(19) United States
(12) Patent Application Publication
(10) Pub. No.: US 2015/0310161 A1
(43) Pub. Date: Oct. 29, 2015

(54) METHOD OF DESIGNING CIRCUIT BOARD INSPECTING JIG, CIRCUIT BOARD INSPECTING JIG, AND CIRCUIT BOARD INSPECTING APPARATUS

(71) Applicant: NIDEC-READ CORPORATION, Kyoto (JP)

(72) Inventors: Michio KAIDA, Kyoto (JP); Toshihide MATSUKAWA, Kyoto (JP); Makoto FUJINO, Kyoto (JP); Osamu HIKITA, Kyoto (JP)

(21) Appl. No.: 14/693,134

(22) Filed: Apr. 22, 2015

(30) Foreign Application Priority Data
Apr. 24, 2014 (JP) 2014-090004

(51) Int. Cl. G06F 17/50

(52) U.S. Cl. CPC G06F 17/5086

(57) ABSTRACT

Provided is a method of designing a circuit board inspecting jig having a contact to be brought into conductive contact with a test point on a circuit board to be inspected. The method includes: preparing temporary design data by temporarily designing the circuit board inspecting jig based on design data for the circuit board to be inspected (a first designing process); acquiring an expansion and contraction ratio of the circuit board based on a condition upon manufacturing the circuit board (and an environmental condition upon inspecting the circuit board) (an expansion and contraction ratio acquiring process); and obtaining design data for the circuit board inspecting jig to be actually manufactured by scaling the temporary design data up and down by the expansion and contraction ratio (a second designing process).

### CROSS-REFERENCE TO RELATED APPLICATION

This application is based on and claims priority from Japanese Patent Application No. 2014-090004, filed on Apr. 24, 2014, the contents of which are hereby incorporated by reference in their entirety.

### TECHNICAL FIELD

This disclosure principally relates to a method of designing a jig configured to inspect a circuit board.

### BACKGROUND

A known circuit board has a predetermined conductor pattern made of a conductive material (e.g., a copper foil, a conductive paste). A circuit board inspecting apparatus, which has been proposed heretofore, includes a circuit board inspecting jig for electrically inspecting the circuit board as to whether or not the conductor pattern formed on the circuit board is defective. The circuit board inspecting jig has a plurality of contacts with conductivity. The circuit board inspecting apparatus applies signals to predetermined test points defined on a circuit board to be inspected, via the contacts, and then measures the signals detected from the circuit board. Thus, the circuit board inspecting apparatus determines whether or not the circuit board is defective.

There is known a technique in which a circuit board inspecting jig of this type. Such a circuit board inspecting jig includes a contact and a holder. The contact is configured to be brought into conductive contact with an inspection point (a test point) on a circuit board. The holder includes an upper plate and a lower plate. The upper plate has a hole for guiding a leading end of the contact toward the inspection point. The lower plate has a hole for guiding a trailing end of the contact toward an electrode to be electrically connected to a main body of a circuit board inspecting apparatus. The circuit board inspecting jig brings the contact into press contact with the circuit board so as to bend the contact in a predetermined curved shape. Then the circuit board inspecting jig moves the contact while rubbing the contact against a surface of the inspection point to be inspected. Thus, the circuit board inspecting jig inspects the circuit board. The circuit board inspecting jig rubs the contact against the inspection point to damage an oxide film on the surface of the inspection point, thereby directly bringing the contact into contact with the inspection point. Thus, the circuit board inspecting jig is capable of preventing an error owing to an influence of the oxide film and the like, upon inspecting the circuit board.

Recently, an improvement in performance, a reduction in size, and a reduction in weight have been increasingly demanded for electronic products. In order to meet such demands, a conductor pattern on a circuit board has been downsized. Moreover, electric components have been more densely packaged and more highly integrated on a circuit board. Accordingly, a dense conductor pattern has been formed on a small circuit board. As a circuit board is manufactured to be smaller, test points for inspecting the circuit board become smaller and are defined more densely on the circuit board. For this reason, a circuit board inspecting jig requires high dimensional accuracy. In order to improve the dimensional accuracy, a known circuit board inspecting jig has been faithfully designed and manufactured in conformity with design data for a circuit board.

A circuit board to be inspected is manufactured through an exposing process, a developing process, a drying process, and the like. In these processes, a circuit board material occasionally expands and contracts owing to a chemical load, a thermal load, and the like applied to circuit board materials. As a result, a slightly significant dimensional error occurs between the actually manufactured circuit board and design data for the circuit board. Moreover, a positional deviation occasionally occurs between a test point on the circuit board and a contact of a circuit board inspecting jig upon inspecting corresponding to the test point. The positional deviation causes an unstable contact state between the contact and the test point, and exerts an adverse influence on the accuracy and efficiency of an inspection. Therefore, the positional deviation needs to be eliminated.

In this respect, there is known a technique capable of preventing an inspection error owing to the oxide film on the surface of the inspection point defined on the circuit board to be inspected. However, there is unknown a positional deviation which occurs between a test point on a circuit board and a contact of a circuit board inspecting jig, owing to a dimensional error occurring upon manufacturing the circuit board.

### SUMMARY

An exemplary embodiment of the disclosure provides a method of designing a circuit board inspecting jig, the method capable of compensating a positional deviation which occurs between a test point on a circuit board and a contact of the circuit board inspecting jig, owing to the expansion and contraction of the circuit board in a process of manufacturing the circuit board.

An exemplary embodiment of the disclosure provides a method of designing a circuit board inspecting jig having a contact to be brought into conductive contact with a test point on a circuit board to be inspected. The method includes: preparing a temporary design data by temporarily designing the circuit board inspecting jig based on a design data for the circuit board to be inspected; acquiring an expansion and contraction ratio of the circuit board based on at least one condition obtained when the circuit board is manufactured; and obtaining a design data for the circuit board inspecting jig to be manufactured by scaling the temporary design data up and down based on the expansion and contraction ratio.

An exemplary embodiment of the disclosure provides a method of designing a circuit board inspecting jig having a contact to be brought into conductive contact with a test point on a circuit board to be inspected. The method includes: acquiring an expansion and contraction ratio of the circuit board based on at least one condition obtained when the circuit board to be inspected is manufactured; scaling a design data for the circuit board up and down based on the expansion and contraction ratio; and designing the circuit board inspecting jig to be manufactured based on the scaled design data for the circuit board.

In acquiring the expansion and contraction ratio acquiring process of the method, the expansion and contraction ratio of the circuit board may be acquired based on at least the condition obtained when the circuit board is manufactured and an environmental condition obtained when the circuit board is inspected.

In acquiring the expansion and contraction ratio of the method, the expansion and contraction ratio of the circuit board may be acquired in consideration of at least a drying condition of the circuit board.

In the method, the circuit board to be inspected may be a flexible circuit board.

In acquiring the expansion and contraction ratio, the expansion and contraction ratio of the circuit board may be independently acquired in a lengthwise direction of the circuit board and a widthwise direction of the circuit board.

In the method, the temporary design data may be independently scaled up and down in the lengthwise direction and the widthwise direction.

An exemplary embodiment of the disclosure provides a circuit board inspecting jig designed by the method.

An exemplary embodiment of the disclosure provides a circuit board inspecting apparatus including the circuit board inspecting jig.

The foregoing and other objects, features, aspects, and advantages of the disclosed invention will become more apparent from the following detailed description, when taken in conjunction with the accompanying drawings.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a schematic front view illustrating a circuit board inspecting apparatus including a circuit board inspecting jig to be designed by a method of designing a circuit board inspecting jig according to an exemplary embodiment;

FIG. 2 is a flowchart illustrating processes of manufacturing and inspecting a circuit board;

FIGS. 3A to 3C schematically illustrate a comparison among an ideal case, a known case, and a case according to an exemplary embodiment, as to a contact state between a contact of the circuit board inspecting jig and a test point on the circuit board; and

FIG. 4 is a flowchart illustrating the method according to an exemplary embodiment.

### DETAILED DESCRIPTION

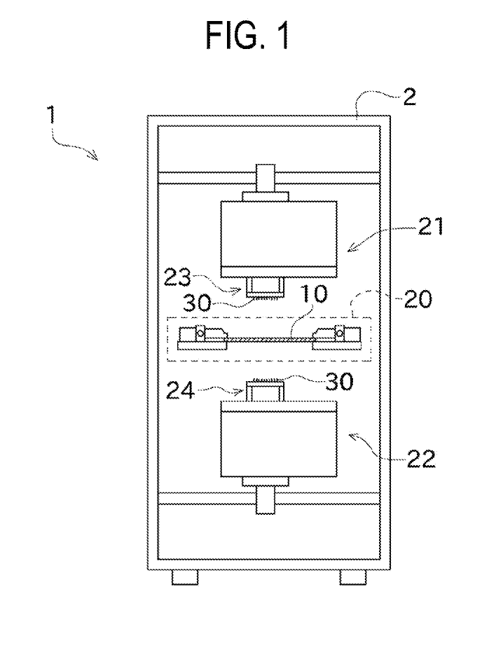

An exemplary embodiment of the disclosure will be described below with reference to the drawings. FIG. 1 is a schematic front view illustrating a circuit board inspecting apparatus 1 including first and second inspecting jigs (referred to as circuit board inspecting jigs) 23 and 24 to be designed by a designing method according to an exemplary embodiment of the disclosure.

The circuit board inspecting apparatus 1 is configured to electrically inspect a circuit board 10 as to whether or not the circuit board 10 has a defect such as a disconnection or a short circuit. As illustrated in FIG. 1, the circuit board inspecting apparatus 1 includes a frame 2. The frame 2 has an internal space where a circuit board fixing device 20, a first inspecting part 21, and a second inspecting part 22 are mainly disposed.

The circuit board 10 to be inspected by the circuit board inspecting apparatus 1 (the first and second inspecting jigs 23 and 24) may be a rigid circuit board or a flexible circuit board with flexibility. Examples of the circuit board to be inspected by the circuit board inspecting apparatus 1 may include a circuit board having a wiring pattern formed thereon, for use in a liquid crystal panel or a plasma display panel, an electrode substrate for use in a touch panel display, a substrate such as a semiconductor wafer, and the like, in addition to a printed circuit board.

The circuit board fixing device 20 includes, for example, a publicly-known clamp mechanism, and is configured to fix the circuit board 10 to be inspected, at a predetermined position.

The first inspecting part 21 is disposed at one side of the circuit board 10 in a thickness direction of the circuit board 10. The second inspecting part 22 is disposed at the other side of the circuit board 10 in the thickness direction. The first inspecting part 21 and the second inspecting part 22 are disposed to face each other.

The first inspecting jig 23 is disposed on the first inspecting part 21 and is oriented to the second inspecting part 22. The second inspecting jig 24 is disposed on the second inspecting part 22 and is oriented to the first inspecting part 21. The first inspecting jig 23 and the second inspecting jig 24 are disposed to face each other. Each of the first inspecting part 21 and the second inspecting part 22 includes a movement mechanism formed of, for example, a screw feed mechanism. According to this configuration, the first inspecting part 21 (the second inspecting part 22) is capable of bringing and separating the first inspecting jig 23 (the second inspecting jig 24) into contact with and from the circuit board 10.

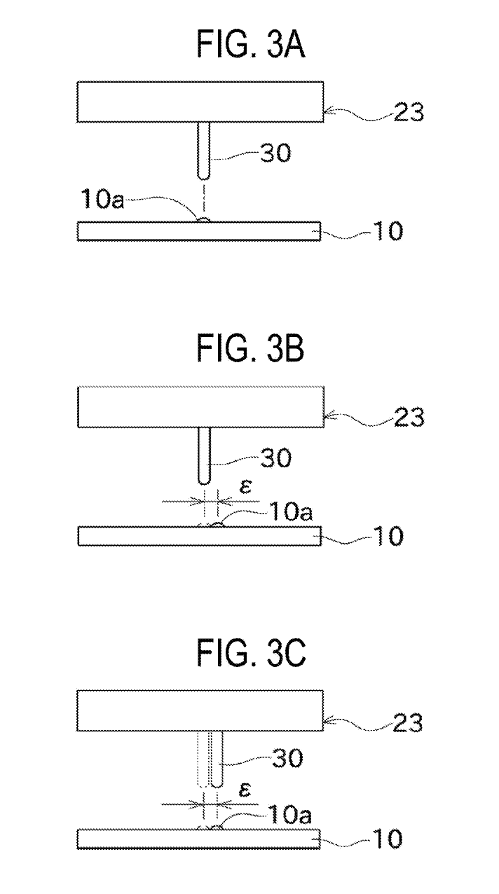

Each of the first inspecting jig 23 and the second inspecting jig 24 has a plurality of contacts 30 with conductivity. Each of the contacts 30 is formed into a needle shape and is oriented to the circuit board 10 (in other words, the opposite inspecting jig). The contacts 30 of the first inspecting jig 23 can be brought into conductive contact with predetermined test points 10a (see FIG. 3A) defined on one surface (a first surface) of the circuit board 10 in the thickness direction of the circuit board 10. FIG. 3A illustrates only the first inspecting jig 23. The contacts 30 of the second inspecting jig 24 can be brought into conductive contact with predetermined test points 10a defined on the other surface (a second surface) of the circuit board 10 in the thickness direction.

In an exemplary embodiment, one or more contacts 30 are provided for each test point 10a defined on the circuit board 10 to be inspected. The contacts 30 are disposed on the first inspecting jig 23 and the second inspecting jig 24, respectively, so as to be brought into contact with the test points 10a on the circuit board 10.

Each of the contacts 30 is electrically connected to a signal supply part (not illustrated) and a signal measurement part (not illustrated) of the circuit board inspecting apparatus 1. The signal supply part is configured to apply signals to the circuit board 10 to be inspected, via the contacts 30 of the first inspecting jig 23 and the contacts 30 of the second inspecting jig 24. The signal measurement part is configured to measure the signals detected from the circuit board 10, in accordance with the signals applied by the signal supply part. Thus, the circuit board 10 can be subjected to an electrical inspection.

The first inspecting jig 23, which can be replaced, is attached to the first inspecting part 21. Likewise, the second inspecting jig 24, which can be replaced, is attached to the second inspecting part 22. According to this configuration, the first and second inspecting jigs 23 and 24 can be replaced each time a circuit board 10 to be inspected is changed. Therefore, this configuration can improve the versatility of the circuit board inspecting apparatus 1.

The first and second inspecting jigs 23 and 24 are designed and manufactured by an inspecting apparatus manufacturer, and then are shipped to a user (e.g., a circuit board manufacturer, an inspection agency) who actually conducts an inspection. More specifically, the user provides design data for a circuit board 10 to be inspected by the circuit board inspecting apparatus 1, to the inspecting apparatus manufacturer who has manufactured the circuit board inspecting apparatus 1. The inspecting apparatus manufacturer designs and manufactures the first and second inspecting jigs 23 and 24, based on the design data, and then delivers the first and second inspecting jigs 23 and 24 to the user. The user conducts an inspection on the circuit board 10 by the use of the circuit board inspecting apparatus 1 equipped with the first and second inspecting jigs 23 and 24.

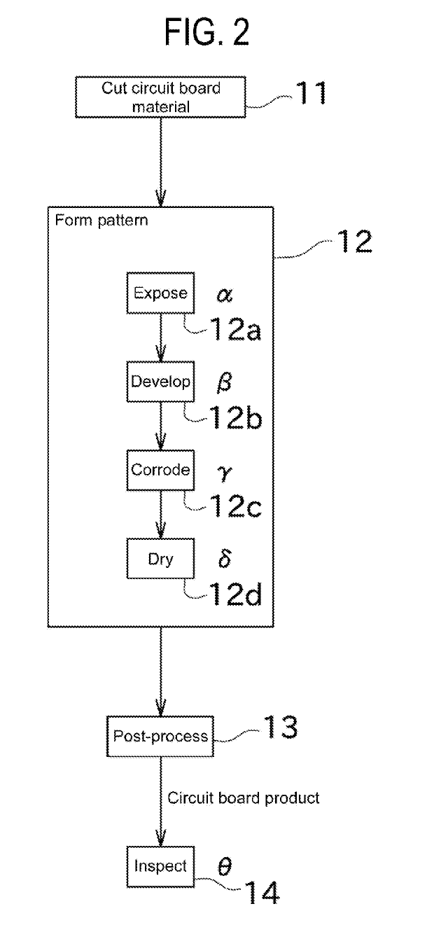

Subsequently, a description will be given of an outline of a process of manufacturing the circuit board 10 to be inspected. In an exemplary embodiment, the circuit board 10 to be inspected may be any kind of circuit boards, as described above. The circuit board 10 to be described below as an example is a printed circuit board having a conductor pattern made of a copper foil as a conductor foil. As illustrated in FIG. 2, a process of manufacturing the circuit board 10 mainly includes a circuit board material cutting process 11, a pattern forming process 12, and a post-process 13. The post-process 13 includes a protective material applying process, a printing process, and the like.

In the circuit board material cutting process 11, a circuit board material is cut into an appropriate size, based on the design data for the circuit board 10. The circuit board material cutting process 11 may be carried out after the pattern forming process 12, the post-process 13, or an inspecting process 14 (to be described later). Moreover, a circuit board manufacturer may optionally set the timing to carry out the circuit board material cutting process 11.

The pattern forming process 12 includes an exposing process 12a, a developing process 12b, a corroding process (etching process) 12c, and a drying process 12d.

In the exposing process 12a, first, a photosensitive agent is applied onto the copper foil formed on the circuit board material. Using a mask prepared based on the design data for the circuit board 10, the photosensitive agent applied to the circuit board material is then selectively photosensitized with, for example, ultraviolet light.

In the developing process 12b, the photosensitized circuit board material is immersed in a developer so that the photosensitive agent is removed from the portion which is photosensitized (or the portion which is not photosensitized). Thus, the copper foil is exposed from the relevant portion.

In the corroding process (etching process) 12c, the developed circuit board material is immersed in an etchant so that the exposed copper foil is removed from the circuit board material.

In the pattern forming process 12, a conductor pattern (a wiring pattern) based on the design data for the circuit board 10 is formed on a surface of the circuit board material through the processes described above.

In the drying process 12d, the circuit board 10 immersed in the developer and the etchant is dried with a dryer or the like. As illustrated in FIG. 2, the drying process 12d of the circuit board 10 is carried out after the corroding process 12c. Typically, the drying process 12d is carried out after each of the remaining processes, if necessary.

The post-process 13 includes, if necessary, a process of applying a resist for protecting the pattern on the circuit board 10 and the circuit board material, a process of printing symbols of electronic components and the like to be mounted on the circuit board 10, a process of forming a hole in the circuit board 10, a process of plating the hole with a conductor such as copper, a process of performing surface treatment on the circuit board 10, a process of defining an outer shape of the circuit board 10, and the like. Thus, the circuit board 10 is manufactured through the processes described above. In the inspecting process 14 subsequent to the processes described above, the circuit board 10 is subjected to an electrical inspection using the circuit board inspecting apparatus 1 equipped with the first and second inspecting jigs 23 and 24.

Various materials of the circuit board 10 are employed in accordance with the kind and use of the circuit board 10. Examples of the circuit board material may include: a paper-phenol material obtained by impregnating a sheet of paper with a phenol resin; a glass-epoxy material obtained by impregnating a laminate of clothes made of glass fiber, with an epoxy resin; a thin polyimide material; and a silicon wafer which is a material for a semiconductor element.

Upon manufacturing the circuit board 10, as described above, it is necessary to heat the circuit board material, cool the circuit board material, immerse the circuit board material in a chemical solution, and dry the circuit board material, in accordance with the manufacturing processes. Influences of the heat, the chemical solution, and the like in these manufacturing processes cause expansion and contraction of the circuit board material. These expansion and contraction cause a dimensional error between the actual complete circuit board 10 and the design data for the circuit board 10. The dimensional error occasionally exerts an adverse influence on the accuracy and efficiency of an inspection using the first and second inspecting jigs 23 and 24. The expansion and contraction of the circuit board material may occur at the process of inspecting the circuit board 10 in addition to the process of manufacturing the circuit board 10.

With reference to FIGS. 3A and 3B, a detailed description will now be given of the dimensional error. FIG. 3A illustrates an ideal contact state between the contact 30 of the first inspecting jig 23 and the test point 10a on the circuit board 10. FIG. 3B illustrates a known positional deviation. For simplification of the description of the positional relationships, FIG. 3A illustrates one contact 30 of the first inspecting jig 23 and one test point 10a on the circuit board 10. In practice, the first inspecting jig 23 has the plurality of contacts 30 disposed thereon, and the circuit board 10 has the plurality of test points 10a defined thereon, as described above.

As illustrated in FIG. 3A, ideally, a leading end of the contact 30 of the first inspecting jig 23 can be brought into contact with a center of the test point 10a on the circuit board 10 to be inspected (the same thing may hold true for the second inspecting jig 24).

In practice, the influence of expansion and contraction of the circuit board material at the time of manufacturing or inspecting the circuit board 10 causes a small but significant dimensional error between the actually manufactured circuit board 10 to be inspected and the original design data for the circuit board 10. On the other hand, the first inspecting jig 23 is faithfully designed and manufactured in conformity with the design data for the circuit board 10. Upon manufacturing the first inspecting jig 23, moreover, the first inspecting jig 23 is hardly subjected to the treatment using the chemical solution, the drying, and the like in the pattern forming process 12. Accordingly, even when a dimensional error occurs between the actually manufactured circuit board 10 and the original design data for the circuit board 10, a positional deviation between the contact 30 of the first inspecting jig 23 and the test point 10a on the circuit board 10 is small.

In the case of conducting an inspection using the first inspecting jig 23 manufactured based on the design data for the circuit board 10, heretofore, the contact 30 of the first inspecting jig 23 occasionally deviates from the center of the test point 10a on the circuit board 10 to be actually inspected, as illustrated in FIG. 3B. Such a positional deviation causes a contact failure between the contact 30 and the test point 10a on the circuit board 10. In the case of forming the conductor pattern in units of micrometers, particularly, it is highly likely that the contact failure between the contact 30 of the first inspecting jig 23 and the test point 10a on the circuit board 10 may occur even when the contact 30 slightly deviates from the center of the test point 10a. Such a contact failure lowers the accuracy and efficiency of an inspection using the first inspecting jig 23.

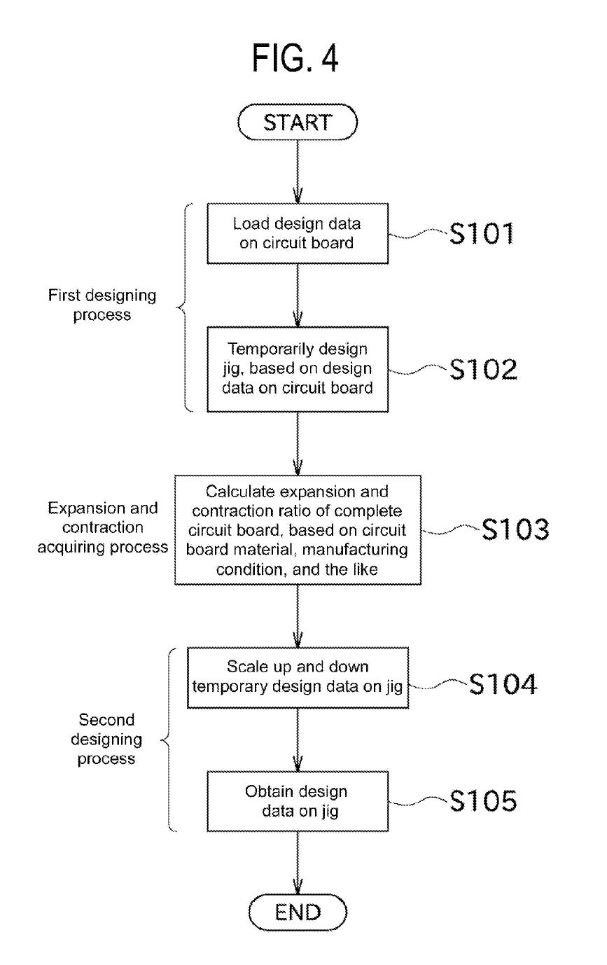

According to an exemplary embodiment, the dimensional change of the circuit board 10 is taken into consideration at the time of designing the first inspecting jig 23. With reference to FIG. 4, a description will now be given of a method of designing the inspecting jigs in accordance with an exemplary embodiment. FIG. 4 is a flowchart illustrating the method of designing the inspecting jigs.

In an exemplary embodiment, the first and second inspecting jigs 23 and 24 are designed by an inspecting apparatus manufacturer, as described above. As illustrated in FIG. 4, the method includes a first designing process, an expansion and contraction ratio acquiring process, and a second designing process.

In the first designing process, the first and second inspecting jigs 23 and 24 are temporarily designed based on the design data for the circuit board 10 provided from the user, and temporary design data for the first and second inspecting jigs 23 and 24 is prepared. The first designing process is substantially equal to a known designing process; therefore, the detailed description thereof will not be given here.

In the expansion and contraction ratio acquiring process, a magnification (an expansion and contraction ratio) between dimensions of the complete circuit board 10 to be inspected and dimensions specified in the design data for the circuit board 10 is acquired by calculation, based on an expansion and contraction ratio of the circuit board 10. The expansion and contraction ratio of the circuit board 10 is specified in accordance with manufacturing conditions in the respective manufacturing processes, and environmental conditions to be assumed in the inspecting process. Examples of such an environmental condition may include a condition for a tension to be applied for holding the circuit board 10 under the tension, a condition for a pressing force to be applied by an inspecting jig to the circuit board 10 in order to inspect the circuit board 10, and the like.

In the second designing process, the temporary design data for the first and second inspecting jigs 23 and 24 designed in the first designing process is scaled up and down based on the expansion and contraction ratio acquired in the expansion and contraction ratio acquiring process, so that actual design data for the first and second inspecting jigs 23 and 24 is obtained.

It is considered herein that the term “scaling” encompasses scaling to be performed in a state in which an aspect ratio is maintained and scaling to be performed (anisotropically) in a state in which the aspect ratio is not maintained.

Since the circuit board 10 has anisotropy, the expansion and contraction ratio in a lengthwise direction of the circuit board 10 and the expansion and contraction ratio in a widthwise direction of the circuit board 10 are not necessarily equal to each other in some cases. In consideration of this respect, according to an exemplary embodiment, the expansion and contraction ratio in the lengthwise direction of the circuit board 10 and the expansion and contraction ratio in the widthwise direction of the circuit board 10 are calculated independently of each other in the expansion and contraction ratio acquiring process. Moreover, the temporary design data in the lengthwise direction and the temporary design data in the widthwise direction are scaled up and down independently of each other in the scaling process.

With reference to FIG. 4, a detailed description will now be given of the respective processes.

First, the design data for the circuit board 10 to be inspected is loaded into CAD (Computer Aided Design) software for designing the first and second inspecting jigs 23 and 24 (step S101). The CAD software may be appropriate software such as two-dimensional CAD or three-dimensional CAD. Subsequently, the first and second inspecting jigs 23 and 24 are temporarily designed on the CAD software, based on the loaded design data (step S102). The operation of temporarily designing the inspecting jigs includes an operation of disposing the contacts 30 of the first and second inspecting jigs 23 and 24 in correspondence with positions of the test points 10a calculated from the design data for the circuit board 10.

When the first and second inspecting jigs 23 and 24 are temporarily designed, an expansion and contraction ratio is subsequently calculated for the design data for the complete circuit board 10 to be inspected, based on conditions of the processes of manufacturing the circuit board 10, environmental conditions to be assumed upon inspecting the circuit board 10, and characteristics of the circuit board material (step S103).

This calculation method is not particularly limited, but may take an expansion and contraction model of the circuit board 10 into consideration. As illustrated in FIG. 2, for example, the expansion and contraction ratio in the exposing process 12a is represented by α, the expansion and contraction ratio in the developing process 12b is represented by β, the expansion and contraction ratio in the corroding process 12c is represented by γ, the expansion and contraction ratio in the drying process 12d is represented by δ, and the expansion and contraction ratio under the environment in the inspecting process 14 is represented by θ.

In the expansion and contraction ratio acquiring process (step S103), first, the expansion and contraction ratios α, β, γ, δ, and θ of the circuit board material in the respective processes are acquired based on data for the manufacturing processes and manufacturing conditions provided from the circuit board manufacturer as well as data for the environmental conditions upon inspecting the circuit board 10. Each of the expansion and contraction ratios α, β, γ, δ, and θ may be theoretically calculated. Alternatively, each the expansion and contraction ratios α, β, γ, δ, and θ may be acquired by referring to a table of experiment results which are empirically obtained in advance under various manufacturing processes, manufacturing conditions, and environmental conditions upon inspecting the circuit board 10.

Examples of a factor which exerts an influence on the expansion and contraction ratios α, β, γ, δ, and θ may include a material and thickness of the circuit board 10. Such a factor is commonly applied to the respective processes. Moreover, specific conditions in the respective manufacturing processes and environmental conditions upon inspecting the circuit board 10 are also considered to exert an influence on the corresponding expansion and contraction ratios α, β, γ, δ, and θ. In the process of exposing the circuit board 10, a factor which exerts an influence on the expansion and contraction ratio α is, for example, an exposure time. In the process of immersing the circuit board 10 in the chemical solution, a factor which exerts an influence on the expansion and contraction ratio β and γ is, for example, a kind, concentration, and temperature of the chemical solution, and a period of time of immersing the circuit board 10 in the chemical solution. In the process of drying the circuit board 10, a factor which exerts an influence on the expansion and contraction ratio 6 is, for example, a drying temperature and a drying period of time. In the process of inspecting the circuit board 10, a factor which exerts an influence on the expansion and contraction ratio θ is, for example, an ambient environment (e.g., temperature, humidity) upon inspecting the circuit board 10.

Values of the expansion and contraction ratios α, β, γ, δ, and θ are stored in the form of, for example, a database (an expansion and contraction ratio memory part) in a computer in which the CAD software are installed or a different computer, with the values correlated with the manufacturing processes, the manufacturing conditions, and the environmental conditions upon inspecting the circuit board 10. In consideration of the respective expansion and contraction ratios α, β, γ, δ, and θ, an expansion and contraction ratio indicating a difference between expansion and contraction of the finally completed circuit board 10 to be inspected and the original design data is calculated in simulation.

The expansion and contraction ratio calculated in this process favorably represents a tendency of a dimensional error occurring between the finally completed circuit board 10 to be inspected and the original design data for the circuit board 10. More specifically, a positional deviation occurring between the test point 10a on the complete circuit board 10 and a test point on the design data, owing to the expansion and contraction of the circuit board material upon manufacturing the circuit board 10 (i.e., a positional deviation ε illustrated in FIG. 3B) can be favorably estimated by the calculation based on the expansion and contraction ratio acquired in the expansion and contraction ratio acquiring process.

Subsequently, the temporary design data designed in the first designing process is scaled up and down on the CAD software, based on the expansion and contraction ratio acquired in the expansion and contraction ratio acquiring process (step S104). The scaling may be performed using a function of performing scaling with an aspect ratio designated independently. This function is one of original functions of the CAD software.

Such as scaling allows a positional adjustment to be made to the contacts 30 of the first and second inspecting jigs 23 and 24. As illustrated in FIG. 3C, more specifically, adjusting the positions of the contacts 30 of the first and second inspecting jigs 23 and 24 allows compensation of the positional deviation ε between the test point 10a on the circuit board 10 and the test point on the design data. Thus, the final design data for the first and second inspecting jigs 23 and 24 is obtained (step S105). The first and second inspecting jigs 23 and 24 are actually manufactured based on the final design data.

As illustrated in FIG. 3C, the contacts 30 of the first and second inspecting jigs 23 and 24 designed by the method described above are expected to be appropriately brought into contact with the test points 10a on the actually manufactured circuit board 10 upon inspecting the circuit board 10. Thus, it is possible to avoid a conduction failure between the first and second inspecting jigs 23 and 24 and the circuit board 10. Therefore, it is possible to considerably improve the accuracy and efficiency of an inspection.

As described above, the first and second inspecting jigs 23 and 24 according to an exemplary embodiment of the disclosure have the contacts 30 which can be brought into conductive contact with the test points 10a on the circuit board 10 to be inspected, respectively. The first and second inspecting jigs 23 and 24 are designed by the method including the first designing process, the expansion and contraction ratio acquiring process, and the second designing process. In the first designing process, the temporary design data which temporarily designs the first and second inspecting jigs 23 and 24 is prepared based on the design data for the circuit board 10 to be inspected. In the expansion and contraction ratio acquiring process, the expansion and contraction ratio of the circuit board 10 is acquired based on the condition upon manufacturing the circuit board 10 (and the environmental condition upon inspecting the circuit board 10). In the second designing process, the design data for the first and second inspecting jigs 23 and 24 to be actually manufactured is obtained by scaling the temporary design data up and down by the expansion and contraction ratio.

With regard to the first and second inspecting jigs 23 and 24 designed by the method, the error upon manufacturing the circuit board 10 to be inspected (and the error based on the environment upon inspecting the circuit board 10) is taken into consideration at the time of designing the first and second inspecting jigs 23 and 24 to thereby be compensated. Thus, it is possible to prevent an actual non-defective circuit board from being detected as a defective. Moreover, it is possible to avoid the occurrence of an error such as a conductive failure. Therefore, it is possible to effectively improve the accuracy and efficiency of an inspection.

In the method described above, the expansion and contraction ratio of the circuit board 10 is acquired based on the condition upon manufacturing the circuit board 10 and the environmental condition to be assumed upon inspecting the circuit board 10.

According to this configuration, it is possible to take not only the expansion and contraction of the circuit board 10 upon manufacturing the circuit board 10, but also the expansion and contraction of the circuit board 10 based on the environment upon inspecting the circuit board 10 into consideration at the time of designing the first and second inspecting jigs 23 and 24. Therefore, it is possible to further improve the accuracy and efficiency of an inspection when using the first and second inspecting jigs 23 and 24.

In the method described above, the expansion and contraction ratio of the circuit board 10 is acquired in consideration of the condition of the drying process 12d for the circuit board 10.

As described above, the expansion and contraction ratio is acquired in consideration of the condition of the drying process 12d in which the circuit board 10 tends to expand and contract. Therefore, it is possible to design the first and second inspecting jigs 23 and 24 with a dimensional change upon manufacturing the circuit board 10 compensated with higher accuracy.

The method according to an exemplary embodiment of the disclosure is preferably employed in a case where the circuit board 10 is a flexible circuit board because of the following reason. That is, since the flexible circuit board tends to expand and contract by an influence of heat and the like, as compared with a so-called rigid circuit board, compensating the influence is more effective.

In the flowchart of FIG. 4, the first and second inspecting jigs 23 and 24 are temporarily designed based on the design data for the circuit board 10, and then the temporary design data for the first and second inspecting jigs 23 and 24 is subjected to the scaling. In place of this procedure, the design data for the circuit board 10 is subjected to scaling by the expansion and contraction ratio (a circuit board scaling process), and then the first and second inspecting jigs 23 and 24 may be designed based on the scaled design data for the circuit board 10 (a designing process). This procedure may also provide an advantageous effect similar to the advantageous effect of the method illustrated in FIG. 4.

The foregoing description concerns an exemplary embodiment of the disclosure and a modification of the embodiment. The configurations described above may be changed as follows.

The operation of calculating the expansion and contraction ratio (the expansion and contraction ratio acquiring process) illustrated in FIG. 4 may be carried out before the operation of temporarily designing the first and second inspecting jigs 23 and 24 (the first designing process).

In an exemplary embodiment, the temporary design data for the inspecting jig and the design data for the circuit board are subjected to scaling on the CAD software. Alternatively, the temporary design data and the design data may be subjected to appropriate coordinate conversion using, for example, coordinate conversion software.

For example, in a case where an environment upon inspecting a circuit board is uncertain, an environmental condition upon inspecting the circuit board is not taken into consideration upon acquiring an expansion and contraction ratio.

The circuit board inspecting jig designed by the method according to an exemplary embodiment of the disclosure is applicable to various inspecting apparatuses in addition to the circuit board inspecting apparatus 1 illustrated in FIG. 1. Moreover, the number of inspecting jigs is not limited to two. For example, the circuit board inspecting jig may be also applicable to a circuit board inspecting apparatus which includes single inspecting part and single inspecting jig and is configured to inspect single surface of a circuit board.

In a case of inspecting a circuit board by the use of a known circuit board inspecting jig faithfully designed in conformity with design data for the circuit board, a dimensional error between the actually manufactured circuit board and the design data for the circuit board induces a contact failure between the circuit board inspecting jig and the circuit board. As a result, there is a possibility in that a non-defective circuit board is determined as a defective. In this respect, the method according to an exemplary embodiment of the disclosure can take a dimensional error occurring upon manufacturing a circuit board into consideration at the time of designing a circuit board inspecting jig, thereby compensating the dimensional error with the design of the circuit board inspecting jig. Thus, it is possible to prevent an actual non-defective circuit board from being detected as a defective. Moreover, it is possible to avoid the occurrence of an error such as a conductive failure. Therefore, it is possible to effectively improve the accuracy and efficiency of an inspection.

The use of the circuit board inspecting jig and the circuit board inspecting apparatus can effectively improve the accuracy and efficiency of an inspection to be conducted on a circuit board.

The foregoing disclosure has been specifically described and illustrated in connection with certain illustrative embodiments. However, it is clearly understood that the embodiments are by way of illustration and example only and are not to be taken by way of limitation. The spirit and scope of the invention are limited only by the terms of the appended claims.

What is claimed is:

1. A method of designing a circuit board inspecting jig having a contact to be brought into conductive contact with a test point on a circuit board to be inspected, the method comprising:
preparing a temporary design data by temporarily designing the circuit board inspecting jig based on a design data for the circuit board to be inspected;
acquiring an expansion and contraction ratio of the circuit board based on at least one condition obtained when the circuit board is manufactured; and
obtaining a design data for the circuit board inspecting jig to be manufactured by scaling the temporary design data up and down based on the expansion and contraction ratio.

2. The method of claim 1, wherein, in acquiring the expansion and contraction ratio, the expansion and contraction ratio of the circuit board is acquired based on the at least one condition obtained when the circuit board is manufactured and an environmental condition obtained when the circuit board is inspected.

3. The method of claim 1, wherein, in acquiring the expansion and contraction ratio, the expansion and contraction ratio of the circuit board is acquired in consideration of at least a drying condition of the circuit board.

4. The method of claim 2, wherein, in acquiring the expansion and contraction ratio, the expansion and contraction ratio of the circuit board is acquired in consideration of at least a drying condition of the circuit board.

5. The method of claim 1, wherein the circuit board to be inspected by the circuit board inspecting jig is a flexible circuit board.

6. The method of claim 2, wherein the circuit board to be inspected by the circuit board inspecting jig is a flexible circuit board.

7. The method of claim 3, wherein the circuit board to be inspected by the circuit board inspecting jig is a flexible circuit board.

8. The method of claim 1, wherein, in acquiring the expansion and contraction ratio, the expansion and contraction ratio of the circuit board is independently acquired in a lengthwise direction of the circuit board and a widthwise direction of the circuit board.

9. The method of claim 8, wherein the temporary design data is independently scaled up and down in the lengthwise direction and the widthwise direction.

10. A circuit board inspecting jig designed by the method of claim 1.

11. A circuit board inspecting apparatus comprising the circuit board inspecting jig of claim 10.

12. A method of designing a circuit board inspecting jig having a contact to be brought into conductive contact with a test point on a circuit board to be inspected, the method comprising:
acquiring an expansion and contraction ratio of the circuit board based on at least one condition obtained when the circuit board to be inspected is manufactured;
scaling a design data for the circuit board up and down based on the expansion and contraction ratio; and
designing the circuit board inspecting jig to be manufactured based on the scaled design data for the circuit board.

13. The method of claim 12, wherein, in acquiring the expansion and contraction ratio, the expansion and contraction ratio of the circuit board is acquired based on the at least one condition obtained when the circuit board is manufactured and an environmental condition obtained when the circuit board is inspected.

14. The method of claim 12, wherein, in acquiring the expansion and contraction ratio, the expansion and contraction ratio of the circuit board is acquired in consideration of at least a drying condition of the circuit board.

15. The method of claim 13, wherein, in acquiring the expansion and contraction ratio, the expansion and contraction ratio of the circuit board is acquired in consideration of at least a drying condition of the circuit board.

16. The method of claim 12, wherein the circuit board to be inspected by the circuit board inspecting jig is a flexible circuit board.

17. The method of claim 13, wherein the circuit board to be inspected by the circuit board inspecting jig is a flexible circuit board.

18. The method of claim 14, wherein the circuit board to be inspected by the circuit board inspecting jig is a flexible circuit board.

19. The method of claim 12, wherein, in acquiring the expansion and contraction ratio, the expansion and contraction ratio of the circuit board is independently acquired in a lengthwise direction of the circuit board and a widthwise direction of the circuit board.

20. The method of claim 19, wherein the design data is independently scaled up and down in the lengthwise direction and the widthwise direction.
